(19) United States
(12) Patent Application Publication
(10) Pub. No.: US 2014/0267587 A1
(43) Pub. Date: Sep. 18, 2014

(54) PANORAMA PACKET

(71) Applicant: MICROSOFT CORPORATION, Redmond, WA (US)

(72) Inventors: Blaise Aguera y Arcas, Seattle, WA (US); Markus Unger, Graz (AT); Sudipta Narayan Sinha, Redmond, WA (US); Eric Joel Stollnitz, Kirkland, WA (US); Matthew T. Uyttendaele, Seattle, WA (US); David Maxwell Gedye, Seattle, WA (US); Richard Stephen Szeliski, Bellevue, WA (US); Johannes Peter Kopf, Bellevue, WA (US); Donald A. Barnett, Monroe, WA (US)

(21) Appl. No.: 13/804,895

(22) Filed: Mar. 14, 2013

(51) Int. Cl. H04N 5/232

(52) U.S. Cl. CPC H04N 5/23238
USPC 348/36

(57) ABSTRACT

One or more techniques and/or systems are provided for generating a panorama packet and/or for utilizing a panorama packet. That is, a panorama packet may be generated and/or consumed to provide an interactive panorama view experience of a scene depicted by one or more input images within the panorama packet (e.g., a user may explore the scene through multi-dimensional navigation of a panorama generated from the panorama packet). The panorama packet may comprise a set of input images may depict the scene from various viewpoints. The panorama packet may comprise a camera pose manifold that may define one or more perspectives of the scene that may be used to generate a current view of the scene. The panorama packet may comprise a coarse geometry corresponding to a multi-dimensional representation of a surface of the scene. An interactive panorama of the scene may be generated based upon the panorama packet.

### BACKGROUND

Many users may create image data using various devices, such as digital cameras, tablets, mobile devices, smart phones, etc. For example, a user may capture an image of a beach using a mobile phone while on vacation. The user may upload the image to an image sharing website, and may share the image with other users. In an example of image data, one or more images may be stitched together to create a panorama of a scene depicted by the one or more images. If the one or more images were captured from varying focal points (e.g., a user sweeps a camera across a scene at arm's length as opposed turning the camera from a stationary pivot point) and/or the one or more images do not adequately depict the scene, then the panorama may suffer from parallax, broken lines, seam lines, resolution fallout, texture blur, or other undesirable effects.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for generating a panorama packet and/or for utilizing a panorama packet are provided herein. In some embodiments, a panorama packet comprises information used to create a visualization, such as a panorama, of a scene that may be visually explored by a user. In an example of generating a panorama packet, a set of input images depicting a scene may be identified. For example, one or more photos depicting a renovated kitchen from various viewpoints may be identified. A camera pose manifold may be estimated based upon the set of input images (e.g., the camera pose manifold may specify various view perspectives from which current views of the scene may be generated). In an example, a graph of the one or more input images may be mapped onto a geometric shape, such as a sphere, and the camera pose manifold is defined by the graph (e.g., the camera pose manifold may comprise rotational data and/or translational data).

A coarse geometry is constructed based upon the set of input images. The coarse geometry corresponds to a multi-dimensional representation of a surface of the scene. In an example where the coarse geometry is initially non-textured, the one or more input images may be projected onto the coarse geometry to texture the coarse geometry to create textured coarse geometry. For example, color values may be assigned to geometry pixels of the textured coarse geometry based upon color values of corresponding pixels of the one or more input images. In this way, the panorama packet is generated to comprise the set of input images, the camera pose manifold, and/or the coarse geometry. In an example, the panorama packet is stored according to a single file format.

In an example, the panorama packet comprises other information that may be used to construct a panorama and/or provide an interactive panorama view experience. For example, a graph may be defined for inclusion within the panorama packet. The graph may specify relational information between respective input images within the set of input images. The graph may comprise one or more nodes connected by one or more edges. A first node may represent a first input image and a second node may represent a second input image. A first edge may connect the first node and the second node. The first edge may represent translational view information between the first input image and the second input image (e.g., a translational view may correspond to a depiction of the scene that is derived from a projection of the first image and the second image onto the coarse geometry because the depiction cannot be completely represented by a single input image). In this way, the panorama packet may comprise the graph, which may be used to translate between one or more views of the scene (e.g., derived from the projection of the one or more input images onto the coarse geometry) from view perspectives defined by the camera pose manifold.

In an example, the panorama packet may be utilized, such as by an image viewing interface, to provide an interactive panorama view experience of the scene (e.g., a user may visually explore the scene by navigating within the panorama to obtain one or more current views of the scene). A request for a current view of the scene may be received (e.g., a user may attempt to navigate within the panorama). Responsive to the current view corresponding to an input image within the panorama packet, the current view may be presented based upon the input image. Responsive to the current view corresponding to a translated view (e.g., a view depicting a sink area and an island area of the renovated kitchen) between a first input image (e.g., depicting the sink area and a microwave area) and a second input image (e.g., depicting the island area and a stove area), the one or more input images (e.g., the first and second input image) may be projected onto the coarse geometry to generate a textured coarse geometry. The translated view may be obtained based upon the textured coarse geometry and/or the camera pose manifold (e.g., a view perspective of the sink area and the island area of the textured coarse geometry from which the translated view may be generated). The current view may be presented based upon the translated view. In an example, the set of input images may be retained within the panorama packet without modification during generation of the panorama (e.g., the set of input images may not be fused and/or stitched together within the panorama packet).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of generating a panorama packet.

FIG. 2 is a component block diagram illustrating an exemplary system for generating a panorama packet.

FIG. 3 is a flow diagram illustrating an exemplary method of utilizing a panorama packet.

FIG. 4 is a component block diagram illustrating an exemplary system for displaying a current view of a panorama.

FIG. 5 is a component block diagram illustrating an exemplary system for displaying a current view of a panorama.

FIG. 6 is a component block diagram illustrating an exemplary system for generating an intermediary panorama to provide an interactive panorama view experience of a scene.

FIG. 7 is a component block diagram illustrating an exemplary system for generating a first panorama of a first region of a scene to provide an interactive panorama view experience of the scene.

FIG. 8 is a component block diagram illustrating an exemplary system for generating a first partial panorama and/or a second partial panorama to provide an interactive panorama experience.

FIG. 9 is an illustration of an exemplary computing device-readable medium wherein processor-executable instructions configured to embody one or more of the provisions set forth herein may be comprised.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

An embodiment of generating a panorama packet is illustrated by an exemplary method 100 of FIG. 1. At 102, the method starts. At 104, a set of input images depicting a scene are identified (e.g., a user may capture one or more photos of a building and outdoor space). At 106, a camera pose manifold is estimated based upon the set of input images. For example, a graph of the set of input images may be mapped onto a geometric shape (e.g., based upon focal points of respective input images), and the camera pose manifold is defined by the graph. The camera pose manifold may comprise rotational data and/or translational data that may be used to generate a current view of the scene depicted by the set of input images (e.g., a panorama of the scene may be generated, and a current view of the panorama may be created based upon a view of the scene along the camera pose manifold).

At 108, a coarse geometry may be constructed based upon the set of input images. The coarse geometry may correspond to a multi-dimensional representation of a surface of the scene. For example, a structure from motion techniques, stereo mapping techniques, utilization of depth values, an image feature matching technique, and/or other techniques may be used to construct the coarse geometry from the set of input images. In an example, the set of inputs images may be projected onto the coarse geometry (e.g., during generation of a panorama) to create textured coarse geometry (e.g., color values of pixels of input images may be assigned to geometry pixels of the coarse geometry).

In some embodiments, a graph may be defined for inclusion within the panorama packet. The graph may specify relational information between respective input images within the set of input images. In an example, the graph comprises a first node representing a first input image, a second node representing a second input image, and a first edge between the first node and the second node. The first edge may represent translation view information between the first input image and the second input image (e.g., a translated view of the scene may correspond to a portion of the scene that is not depicted by a single input image, but may be based upon a view derived from multiple input images which may be projected onto the coarse geometry to obtain the translated view). In this way, the graph may be utilized to generate one or more current views provided during an interactive panorama view experience of the scene through a panorama generated using the panorama packet.

At 110, the panorama packet may be generated. The panorama packet may comprise the set of input images, the camera pose manifold, the coarse geometry, the graph, and/or other information. In an example, the set of input images may be retained within the panorama packet, such as during panorama generation, without modification to the set of input images (e.g., the set of input images may not be fused together during an interactive panorama view experience of the scene). In an example, the panorama packet may be stored according to a single file format (e.g., a file that may be consumed by an image viewing interface). The panorama packet may be utilized (e.g., by an image viewing interface) to provide an interactive panorama view experience of the scene through a panorama created from the panorama packet. At 112, the method ends.

FIG. 2 illustrates an example of a system 200 for generating a panorama packet 206. The system 200 comprises a packet generating component 204. The packet generating component 204 is configured to identify a set of input images 202. In an example, one or more input images may be selected for identification as the set of input image 202 based upon various criteria, such as a relatively similar name, a relatively similar description, captured by the same camera, captured by the same image capture program, image features depicting a similar scene, images taken within a temporal threshold, etc. The set of input images 202 may depict a scene, such as a building and outdoor space, from various viewpoints.

The packet generating component 204 may be configured to estimate a camera pose manifold 210, such as based on the camera position and/or orientation information for respective input images, for example. The camera pose manifold 210 may comprise one or more focal points for view perspectives of the scene (e.g., a view perspective from which a user may view the scene through a panorama generated based upon the panorama packet 206). The packet generating component 204 may be configured to construct a coarse geometry 212 corresponding to a multi-dimensional representation of a surface of the scene. In some embodiments, the packet generating component 204 may be configured to generate a graph 214 representing relational information between respective input images within the set of input images 202, which may be used to derive a current view of the panorama. The packet generating component 204 may generate the panorama packet 206 based upon the set of input images 202, the camera pose manifold 210, the coarse geometry 212, the graph 214, and/or other information used to generate a panorama.

An embodiment of utilizing a panorama packet is illustrated by an exemplary method 300 of FIG. 3. At 302, the method starts. A panorama packet (e.g., panorama packet 206 of FIG. 2) may comprise a set of input images, a camera pose manifold, a coarse geometry, a graph, and/or other information that may be used to generate a panorama. In an example, an image viewing interface may provide an interactive panorama view experience of a scene depicted by the panorama. For example, a user may explore the scene by navigating the panorama in multi-dimensional space (e.g., three-dimensional space). The image viewing interface may display one or more current views of the scene responsive to the user navigating the panorama.

At 304, a request for a current view of the scene associated with the panorama packet is received. For example, the current view may correspond to navigational input through the panorama (e.g., the user may navigate towards a building depicted within the panorama of the scene). At 306, responsive to the current view corresponding to an input image within the panorama packet, the current view may be presented based upon the input image (e.g., an input image may adequately depict the building from a view perspective defined by the camera pose manifold).

At 308, responsive to the current view of the scene corresponding to a translated view between a first input image (e.g., depicting a first portion of the building) and a second input image (e.g., depicting a second portion of the building), one or more input images are projected onto the coarse geometry to generate a textured coarse geometry. In an example, a first portion of the first input image is blended with a second portion of the second input image to define textured data (e.g., color values) for a first portion of the coarse geometry (e.g., a blending technique performed based upon overlap between the first and second input images). In another example, a portion of the geometry (e.g., an occluded portion) may be inpainted because of a lack of textured data for the portion. The translated view may be obtained based upon a view perspective, defined by the camera pose manifold, of the textured coarse geometry. In an example, the set of input images are projected onto proxy geometry corresponding to a multi-dimensional reconstruction of the scene to create textured proxy geometry, which may be used to fuse the panorama using a shared artificial focal point corresponding to an average center viewpoint of the set of input images. In another example, the set of input images are retained within the panorama packet, and are not stitched and/or fused together during generation of the current view. In this way, the current view is presented based upon the translated view. At 310, the method ends.

FIG. 4 illustrates an example of a system 400 for displaying a current view 414 of a panorama 406. The system 400 may comprise an image viewing interface component 404. The image viewing interface component 404 may be configured to provide an interactive panorama view experience of a scene corresponding to a panorama packet 402 (e.g., panorama packet 206 of FIG. 2). The panorama packet 402 may comprise a set of input images depicting the scene, such as a building and outdoor space. The panorama packet 402 may comprise a camera pose manifold, as well as a coarse geometry onto which the set of input images may be projected to generate textured coarse geometry. One or more current views of the scene may be identified using a graph comprised within the panorama packet 402 (e.g., the graph may comprise relationship information between respective input images). In this way, a current view may be obtained from an input image or the textured coarse geometry (e.g., if the current view is not adequately depicted by a single input image, then the current view may be derived from a translated view of the textured coarse geometry along the camera pose manifold). It may be appreciated that in an example, navigation of the panorama 406 may correspond to multi-dimensional navigation, such as three-dimensional navigation, and that merely one-dimensional and/or two-dimensional navigation are illustrated for simplicity.

In an example, the set of input images of the panorama packet comprise a first input image 408 (e.g., depicting a building and a portion of a cloud), a second input image 410 (e.g., depicting a portion of the cloud and a portion of a sun), a third input image 412 (e.g., depicting a portion of the sun and a tree), and/or other input images depicting overlapping portions of the scene and/or non-overlapping portions of the scene (e.g., a fourth input image may depict the entire sun, a fifth input image may depict the building and the cloud, etc.). A user may navigate to a top portion of the building depicted by the scene. The image viewing interface component 404 may be configured to provide the current view 414 based upon the first input image 408, which may adequately depict the top portion of the building.

FIG. 5 illustrates an example of a system 500 for displaying a current view 514 of a panorama 506. The system 500 may comprise an image viewing interface component 504. The image viewing interface component 504 may be configured to provide an interactive panorama view experience of a scene corresponding to a panorama packet 502 (e.g., panorama packet 206 of FIG. 2). The panorama packet 502 may comprise a set of input images depicting the scene; a coarse geometry onto which the set of input images may be projected to generate textured coarse geometry; a camera pose manifold; and/or a graph specifying relational information between respective input images. One or more current views of the scene may be identified using a graph comprised within the panorama packet. In this way, a current view may be obtained from an input image or the textured coarse geometry (e.g., if the current view is not adequately depicted by a single input image, then the current view may be derived from a translated view of the textured coarse geometry along the camera pose manifold). It may be appreciated that in an example, navigation of the panorama 506 may correspond to multi-dimensional navigation, such as three-dimensional navigation, and that merely one-dimensional and/or two-dimensional navigation are illustrated for simplicity.

In an example, the set of input images of the panorama packet comprise a first input image 508 (e.g., depicting a building and a portion of a cloud), a second input image 510 (e.g., depicting a portion of the cloud and a portion of a sun), a third input image 512 (e.g., depicting a portion of the sun and a tree), and/or other input images depicting overlapping portions of the scene and/or non-overlapping portions of the scene (e.g., a fourth input image may depict the entire sun, a fifth input image may depict the building and the cloud, etc.). A user may navigate to towards the cloud and sun depicted within the scene. The current view 514 of the cloud and sun may correspond to a translated view between the second input image 510 and the third input image 512 (e.g., the current view 514 may correspond to a point along an edge connecting the second input image 510 and the third input image 512 within the graph of the panorama packet 502). Accordingly, the image viewing interface component 504 may be configured to project one or more input images onto the coarse geometry to generate the textured coarse geometry. The translated view may be obtained based upon a view perspective, as defined by the camera pose manifold, of the textured coarse geometry. The image viewing interface component 504 may be configured to provide the current view 514 based upon the translated view.

FIG. 6 illustrates an example of a system 600 configured for generating an intermediary panorama 606 to provide an interactive panorama view experience 612 of a scene. The system 600 comprises an image viewing interface component 604. The image viewing interface component 604 may be configured to provide the interactive panorama view experience 612 based upon a set of input images 608, coarse geometry, a camera pose manifold, a graph, and/or other information within a panorama packet 602. The image viewing interface component 604 may be configured to generate the intermediary panorama 606 of the scene using the set of input images. In an example, the intermediary panorama 606 may correspond to a fused panorama (e.g., one or more input images may be fused together). In another example, the intermediary panorama 606 may correspond to a stitched panorama (e.g., one or more input images are stitched together). The image viewing interface component 604 may be configured to blend the intermediary panorama 606 with the set of input images 608 using a blending technique 610 to generate a panorama of the scene. In this way, the interactive panorama view experience 612 for the panorama may be provided (e.g., a user may be able to explore the scene by multi-dimensional navigation).

FIG. 7 illustrates an example of a system 700 configured for generating a first panorama 706 of a first region of a scene to provide an interactive panorama view experience 712 of the scene. The system 700 comprises an image viewing interface component 704. The image viewing interface component 704 may be configured to provide the interactive panorama view experience 712 based upon a set of input images, coarse geometry, a camera pose manifold, a graph, and/or other information within a panorama packet 702. The image viewing interface component 704 may be configured to segment the scene into one or more regions based upon a content segmentation technique 710. For example, a first region may correspond to a background of the scene and a second region may correspond to a foreground of the scene. The image viewing interface component 704 may generate the first panorama 706 for the first region because parallax error and/or other error occurring in the background (e.g., which may result from a stitching process used to generate the first panorama 706) may have an adverse, but possibly marginal, effect on visual quality of the interactive panorama view experience 712. Accordingly, one or more input images corresponding to the first region may be stitched together to make the first panorama 706. The image viewing interface component 704 may represent the second region using one or more input images 708 corresponding to the second region. For example, a visualization, such as a spin movie, may be used to represent objects within the second region, such as the foreground of the scene. In this way, the first panorama 706 may be used for the background and the one or more input images 708 may be used for the foreground to provide the interactive panorama view experience 712.

FIG. 8 illustrates an example of a system 800 configured for generating a first partial panorama 806 and/or a second partial panorama 808 to provide an interactive panorama experience 812. The system 800 comprises an image viewing interface component 804. The image viewing interface component 804 may be configured to provide the interactive panorama view experience 812 based upon a set of input images, coarse geometry, a camera pose manifold, a graph, and/or other information within a panorama packet 802. The image viewing interface component 804 may be configured to cluster respective input images within the panorama packet 802 based upon an alignment detection techniques 810. For example, one or more input images having a first focal point alignment above a threshold may be grouped into a first cluster; one or more input images having a second focal point alignment above the threshold may be grouped into a second cluster; etc. The image viewing interface component 804 may be configured to generate the first partial panorama 806 based upon the first cluster (e.g., the first partial panorama 806 may correspond to a first portion of the scene depicted by the one or more input images within the first cluster). The image viewing interface component 804 may be configured to generate the second partial panorama 808 based upon the second cluster (e.g., the second partial panorama 808 may correspond to a second portion of the scene depicted by the one or more input images within the second cluster). In this way, the first partial panorama 806 (e.g., to display a current view corresponding to the first portion of the scene) and/or the second partial panorama 808 (e.g., to display a current view corresponding to a second portion of the scene) may be used to provide the interactive panorama view experience.

Still another embodiment involves a computer-readable medium comprising processor-executable instructions configured to implement one or more of the techniques presented herein. An example embodiment of a computer-readable medium or a computer-readable device that is devised in these ways is illustrated in FIG. 9, wherein the implementation 900 comprises a computer-readable medium 908, such as a CD-R, DVD-R, flash drive, a platter of a hard disk drive, etc., on which is encoded computer-readable data 906. This computer-readable data 906, such as binary data comprising at least one of a zero or a one, in turn comprises a set of computer instructions 904 configured to operate according to one or more of the principles set forth herein. In some embodiments, the processor-executable computer instructions 904 are configured to perform a method 902, such as at least some of the exemplary method 100 of FIG. 1 and/or at least some of the exemplary method 300 of FIG. 3, for example. In some embodiments, the processor-executable instructions 904 are configured to implement a system, such as at least some of the exemplary system 200 of FIG. 2, at least some of the exemplary system 400 of FIG. 4, at least some of the exemplary system 500 of FIG. 5, at least some of the exemplary system 600 of FIG. 6, at least some of the exemplary system 700 of FIG. 7, and/or at least some of the exemplary system 800 of FIG. 8, for example. Many such computer-readable media are devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component is localized on one computer or distributed between two or more computers.

Furthermore, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 10 and the following discussion provide a brief, general description of a suitable computing environment to implement embodiments of one or more of the provisions set forth herein. The operating environment of FIG. 10 is only an example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions are implemented as program modules, such as functions, objects, Application Programming Interfaces (APIs), data structures, and the like, that perform particular tasks or implement particular abstract data types. Typically, the functionality of the computer readable instructions are combined or distributed as desired in various environments.

FIG. 10 illustrates an example of a system 1000 comprising a computing device 1012 configured to implement one or more embodiments provided herein. In one configuration, computing device 1012 includes at least one processing unit 1016 and memory 1018. In some embodiments, depending on the exact configuration and type of computing device, memory 1018 is volatile, such as RAM, non-volatile, such as ROM, flash memory, etc., or some combination of the two. This configuration is illustrated in FIG. 10 by dashed line 1014.

In other embodiments, device 1012 includes additional features or functionality. For example, device 1012 also includes additional storage such as removable storage or non-removable storage, including, but not limited to, magnetic storage, optical storage, and the like. Such additional storage is illustrated in FIG. 10 by storage 1020. In some embodiments, computer readable instructions to implement one or more embodiments provided herein are in storage 1020. Storage 1020 also stores other computer readable instructions to implement an operating system, an application program, and the like. Computer readable instructions are loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media is part of device 1012.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1012 includes input device(s) 1024 such as keyboard, mouse, pen, voice input device, touch input device, infrared cameras, video input devices, or any other input device. Output device(s) 1022 such as one or more displays, speakers, printers, or any other output device are also included in device 1012. Input device(s) 1024 and output device(s) 1022 are connected to device 1012 via a wired connection, wireless connection, or any combination thereof. In some embodiments, an input device or an output device from another computing device are used as input device(s) 1024 or output device(s) 1022 for computing device 1012. Device 1012 also includes communication connection(s) 1026 to facilitate communications with one or more other devices.

Although the subject matter has been described in language specific to structural features and/or methodological acts, it is to be understood that the subject matter of the appended claims is not necessarily limited to the specific features or acts described above. Rather, the specific features and acts described above are disclosed as example forms of implementing the claims.

Various operations of embodiments are provided herein. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

It will be appreciated that layers, features, elements, etc. depicted herein are illustrated with particular dimensions relative to one another, such as structural dimensions and/or orientations, for example, for purposes of simplicity and ease of understanding and that actual dimensions of the same differ substantially from that illustrated herein, in some embodiments.

Further, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims.

What is claimed is:

1. A method for generating a panorama packet, comprising:
identifying a set of input images depicting a scene;
estimating a camera pose manifold based upon the set of input images;
constructing a coarse geometry based upon the set of input images, the coarse geometry corresponding to a multi-dimensional representation of a surface of the scene; and
generating a panorama packet comprising the set of input images, the camera pose manifold, and the coarse geometry.

2. The method of claim 1, comprising:
defining a graph, for inclusion within the panorama packet, specifying relational information between respective input images within the set of input images, the graph comprising a first node representing a first input image, a second node representing a second input image, and a first edge between the first node and a second node, the first edge representing translational view information between the first input image and the second input image.

3. The method of claim 1, comprising:
utilizing the panorama packet, by an image viewing interface, to provide an interactive panorama view experience of the scene.

4. The method of claim 3, comprising:
responsive to a current view of the scene, provided by the image viewing interface, corresponding to an input image, presenting the current view based upon the input image.

5. The method of claim 3, comprising:
responsive to a current view of the scene, provided by the image viewing interface, corresponding to a translated view between a first input image and a second input image:
projecting one or more input images onto the coarse geometry to generate a textured coarse geometry; and
obtaining the translated view based upon the textured coarse geometry.

6. The method of claim 5, the projecting comprising at least one of:
blending a first portion of the first input image with a second portion of the second input image to define textured data for a first portion of the coarse geometry; or
inpainting a second portion of the coarse geometry.

7. The method of claim 3, comprising:
translating between one or more views of the scene, provided by the image viewing interface, from a view perspective defined by the camera pose manifold.

8. The method of claim 7, comprising:
retaining the set of input images within the panorama packet, the set of input images not stitched together to provide the interactive panorama view experience.

9. The method of claim 1, comprising:
projecting the set of input images onto a proxy geometry corresponding to a multi-dimensional reconstruction of the scene to create textured proxy geometry; and
fusing a panorama from the textured proxy geometry using a shared artificial focal point corresponding to an average center viewpoint of the set of input images.

10. The method of claim 1, comprising:
generating an intermediary panorama of the scene using the set of input images, the intermediary panorama corresponding to at least one of a stitched panorama or a fused panorama; and
blending the intermediary panorama with at least one input image to generate a panorama of the scene.

11. The method of claim 1, comprising:
generating one or more partial panoramas using the set of input images, a first partial panorama derived from a first image subset within the set of input images based upon the first image subset comprising one or more input images having an alignment factor above an alignment threshold.

12. The method of claim 1, comprising:
segmenting the scene into a first region and a second region;
generating a first panorama for the first region; and
presenting a current view of the scene based upon the first panorama and one or more input images corresponding to the second region.

13. The method of claim 1, comprising:
storing the panorama packet according to a single file format.

14. A method for utilizing a panorama packet, comprising:
receiving a request for a current view of a scene associated with a panorama packet comprising a set of input images depicting the scene, a camera pose manifold, and a coarse geometry corresponding to a multi-dimensional representation of a surface of the scene;
responsive to the current view of the scene corresponding to an input image, presenting the current view based upon the input image; and
responsive to the current view of the scene corresponding to a translated view between a first input image and a second input image:
projecting one or more input images onto the coarse geometry to generate a textured coarse geometry;
obtaining the translated view based upon the textured coarse geometry and the camera pose manifold; and
presenting the current view based upon the translated view.

15. The method of claim 14, the projecting comprising at least one of:
blending a first portion of the first input image with a second portion of the second input image to define textured data for a first portion of the coarse geometry; or
inpainting a second portion of the coarse geometry.

16. The method of claim 14, comprising:
segmenting the scene into a first region and a second region based upon the textured coarse geometry;
generating a first panorama for the first region; and
presenting the current view of the scene based upon the first panorama and one or more input images corresponding to the second region.

17. The method of claim 16, the first region corresponding to a background of the current view and the second region corresponding to a foreground of the current view.

18. The method of claim 14, the obtaining the translated view comprising:
retaining the set of input images within the panorama packet, the set of input images not stitched together.

19. A system for panorama packet generation, comprising:
a packet generating component configured to:
identify a set of input images depicting a scene;
estimate a camera pose manifold based upon the set of input images;
construct a coarse geometry based upon the set of input images, the coarse geometry corresponding to a multi-dimensional representation of a surface of the scene;
define a graph specifying relational information between respective input images within the set of input images; and
generate a panorama packet comprising the set of input images, the camera pose manifold, the coarse geometry, and the graph.

20. The system of claim 19, comprising:
an image viewing interface component configured to:
responsive to a current view of the scene corresponding to an input image, present the current view based upon the input image; and
responsive to the current view of the scene corresponding to a translated view between a first input image and a second input image:
project one or more input images onto the coarse geometry to generate a textured coarse geometry;
obtain the translated view based upon the textured coarse geometry and the camera pose manifold; and
present the current view based upon the translated view.
